(19) United States
(12) Patent Application Publication
(10) Pub. No.: US 2007/0080106 A1
(43) Pub. Date: Apr. 12, 2007

(54) Oil filter housing

(75) Inventors: Jeremy J. Gilles, Malone, WI (US); Terrence M. Rotter, Sheboygan Falls, WI (US); Kevin G. Bonde, Kiel, WI (US)

Correspondence Address: WHYTE HIRSCHBOECK DUDEK S C, 555 EAST WELLS STREET, SUITE 1900, MILWAUKEE, WI, 53202, US

(73) Assignee: Kohler Co.

(21) Appl. No.: 11/248,084

(22) Filed: Oct. 12, 2005

(51) Int. Cl. B01D 27/00

(52) U.S. Cl. 210/450; 210/232; 123/188.9; 184/6.24

(57) ABSTRACT

A spin-on oil filter can be mounted in an easily accessible position on an engine by means of an oil filter housing comprising a lower housing unit, which comprises an open-topped chamber, and an upper housing unit. A male threaded portion, adapted to mount a spin-on oil filter, extends up from the bottom surface of the lower housing unit. A flat gasket sealing surface is located on the bottom surface, wherein the gasket surface is perpendicular with the male threaded portion. The housing comprises three passages: (i) a first passage adapted to permit flow of dirty oil to an oil filter mounted on the male threaded portion; (ii) a second passage adapted to permit flow of filtered oil away from an oil filter mounted on the male threaded portion; and, (iii) a third passage adapted to permit drainage of oil from the open-topped chamber. The upper housing unit is removably attached to the lower housing unit, and is adapted to cover the open-topped chamber. Methods of maintaining the filter and of adding refill oil are facilitated by this housing.

### FIELD OF THE INVENTION

This invention relates generally to oil filters for internal combustion engines, and more specifically to providing easier access to the oil filter.

### BACKGROUND OF THE INVENTION

Many small utility engines are provided with an oil filter to remove harmful contaminants from the engine lubricating oil, thereby extending the life of the engine. The most common type of filter used is an automotive style spin-on filter. This type of filter is low in cost and has many of the features generally required of an oil filter built into the disposable assembly (such as a housing capable of withstanding the system operating pressure and a pressure relief valve to prevent oil starvation should the filter element become plugged).

One main problem encountered with using this type of filter is mounting it to the engine crankcase where it will be readily accessible for service. Another problem associated with this filter is collecting spilled oil when removing the old oil filter. In many typical placements of a spin-on type of oil filter, what appears to be an accessible location on a bare engine becomes difficult to access and service when the engine is installed in an application.

Many small utility engine designs have filters that are mounted low on the engine, near the mounting base where the engine is fastened to the application it is powering. In many applications for small utility engines, the engine mounting base is found low in the unit and surrounded by components that can make access to the oil filter very difficult. A review of small utility engine applications will show the top-side of the engine is generally accessible in many applications. Using conventional methods of attaching a spin-on oil filter to the engine crankcase, locating the filter on the top-side of the engine would result in the filter oriented upside down. During removal for servicing, much of the oil contained within the filter would spill over the top of the engine.

Another option commonly used to improve access to oil filters when the installation leaves little room for servicing, is to remote-mount the filter, using hoses or other external conduits to carry the oil to the remotely mounted filter. This is an expensive option, adding a pair of expensive hose assemblies and a remote-mounting bracket, but is preferable to an application with an inaccessible oil filter.

There are existing oil filter housing designs that can overcome the problems listed with the above designs (access to filter, spillage during servicing, and use as an oil fill), but these designs do not use spin-on oil filters. These known variations use cartridge type oil filters. Examples of this type of filter design include the following U.S. Pat. Nos. 6,706,181; 6,379,537; 6,101,996; 5,698,098, and 5,516,425. Any of these existing concepts could be incorporated into the top-side of an engine to overcome the limitations previously described in this disclosure, but cartridge filters have their own limitations (discussed further below) and there are other advantages in using the spin-on filter of this invention over the cartridge type filter described in these patents.

While the cartridge filter element itself is relatively inexpensive, other features that are provided integrally with a spin-on filter must be provided separately in the filter housing when using a cartridge type filter. These features include element support to prevent paper collapse, bypass function for when the element is plugged or the oil is very cold and viscous (to prevent oil starvation to the engine bearings), element sealing to provide a proper oil flow path, a structure that can withstand the operating pressure of the oil lubrication system, and a drain valve for removal of oil within the filter assembly when servicing the filter element. Utilizing a low cost spin-on filter to provide these features puts the design complexity into the filter itself and allows the housing unit design to be simple and low cost.

### BRIEF SUMMARY OF THE INVENTION

The Applicants have found that mounting a spin-on oil filter within a generally cup-shaped housing on top of an engine crankcase allows for easy access to change the filter, without spilling over the engine or ground, and also provides a convenient location to add re-fill oil to the crankcase.

In one embodiment, the invention is an oil filter housing comprising a lower housing unit, which comprises an at least approximately circular sidewall connected to a bottom surface to form an open-topped chamber, and an upper housing unit. A male threaded portion, adapted to mount a spin-on oil filter, extends up from the bottom surface. A flat gasket surface is located on the bottom surface, wherein the gasket surface is concentric with the sidewall. The housing comprises three passages: (i) a first passage adapted to permit flow of dirty oil to an oil filter mounted on the male threaded portion, wherein the first passage is located in the bottom surface inside the gasket surface; (ii) a second passage adapted to permit flow of filtered oil away from an oil filter mounted on the male threaded portion, wherein the second passage is located in the male threaded portion; and, (iii) a third passage adapted to permit drainage of oil from the open-topped chamber, wherein the third passage is located in the bottom surface outside of the gasket surface. The upper housing unit is removably attached to the lower housing unit, and is adapted to cover the open-topped chamber. The oil filter housing is adapted to allow a spin-on oil filter to be mounted in a normally inverted position on or above a top side of an internal combustion engine.

### BRIEF DESCRIPTION OF THE DRAWINGS

Preferred embodiments of the invention are described below with reference to the accompanying drawings, which are for illustrative purposes only. Throughout the following views, reference numerals will be used in the drawings, and the same reference numerals will be used throughout the several views, and in the description, to indicate same or like parts or steps.

FIG. 1 shows a side elevation view of the lower housing unit.

FIG. 2 shows a top plan view of the lower housing unit.

FIG. 3 is a top oblique view of the upper housing unit.

FIG. 4 shows a cross-sectional view of the assembled oil filter assembly.

FIG. 5 shows the oil filter assembly mounted on a horizontal crankshaft engine.

FIG. 6 shows the mounted oil filter assembly of FIG. 5 with the upper housing removed to expose the oil filter.

FIG. 7 shows the mounted oil filter assembly of FIG. 5 with both the upper housing and the oil filter removed.

FIG. 8 shows the oil filter assembly mounted on a vertical crankshaft engine.

FIG. 9 shows the mounted oil filter assembly of FIG. 8 with the upper housing removed to expose the oil filter.

FIG. 10 shows the mounted oil filter assembly of FIG. 8 with both the upper housing and the oil filter removed.

### DETAILED DESCRIPTION OF THE INVENTION

In at least some embodiments, the invention consists of a two-piece, roughly cylindrical housing, having lower and upper housing units that are constructed of plastic, aluminum, or other such appropriate material. The lower housing unit can be integrally formed with the engine crankcase, or can be a separate component that mounts to the engine crankcase (the design shown is separately mounted). The bottom surface of the lower housing unit consists of a male threaded portion extending up from the bottom surface (to mount the spin-on oil filter) and a concentric flat gasket surface (for the spin-on filter gasket to seal against). The lower housing unit has either threaded or quarter-turn type details on the outside wall to facilitate connection with the upper housing unit (quarter-turn details are shown).

Spin-on oil filters are well-known in the art. One end of the filter has a threaded hole to engage with spin-on mounts, as well as openings to allow ingress and egress of oil. This end is considered the “top” end of the filter.

The lower housing unit contains a total of three oil passages communicating with the bottom surface of the lower housing unit. Two passages are located inside the filter gasket surface portion of the lower housing unit: the first is a passage bringing dirty oil to the filter (through the hole located just inside of the gasket surface) and the second a passage returning cleaned oil to the engine lubrication system (through the hole located in the male threaded portion). A drain passage is located near the outer wall of the lower housing unit, connecting to the interior of the engine crankcase and allowing any oil in the lower housing unit (outside of the oil filter gasket) to drain back into the engine crankcase.

The upper housing unit is essentially a cover to the lower housing unit, containing either threaded or quarter-turn type details to mate with the lower housing unit (quarter-turn shown). The upper housing unit is preferably larger in diameter than the lower housing unit, and overlaps a significant portion of the lower housing unit sidewalls. A sealing element is positioned between the upper and lower housing unit sidewalls to keep any oil contained within the housing assembly. Preferred embodiments of the invention are described in more detail below.

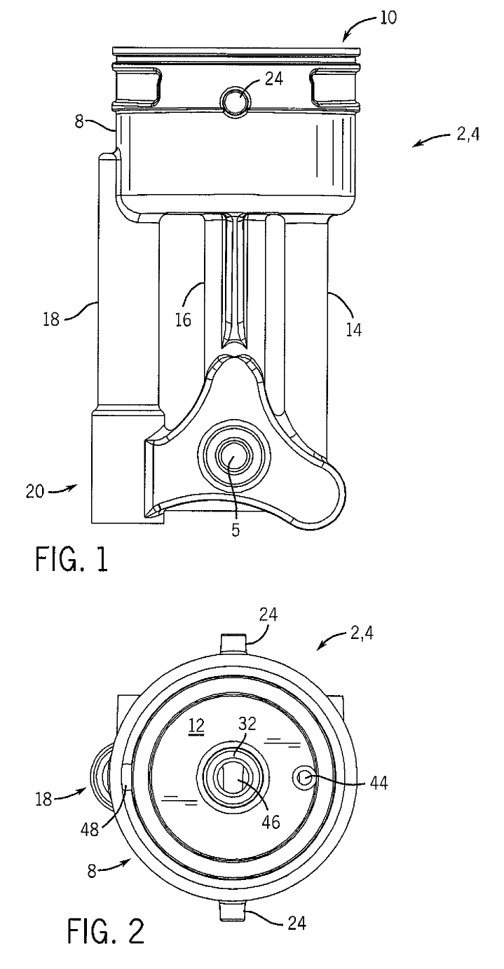

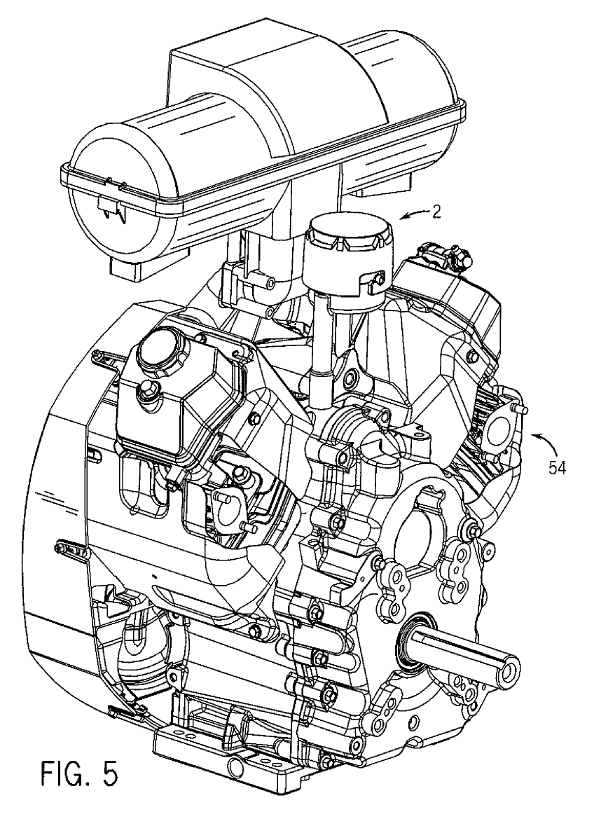

The oil filter assembly 2 is shown in FIGS. 1-10. As shown in FIGS. 1-3, the oil filter assembly 2 includes a lower housing unit 4 and an upper housing unit 6. FIG. 1 shows a side elevation view of the lower housing unit 4, while FIG. 2 shows a top plan view of the lower housing unit. The lower housing unit 4 includes a cup-shaped portion 8 with an open upper end 10 and a closed lower end 12. Additionally, extending downward below the cup-shaped portion 8 are first, second and third supports 14, 16 and 18, respectively. The supports 14, 16, 18 are rejoined to one another at a base 20 of the lower housing unit 4, which includes a bolt hole 5 by which the assembly 2 can be mounted on an engine crankcase (see FIGS. 5-10). In an alternative embodiment, lower housing unit 4 can be formed integrally with the crankcase and one or more of supports 14, 16, 18 might be eliminated.

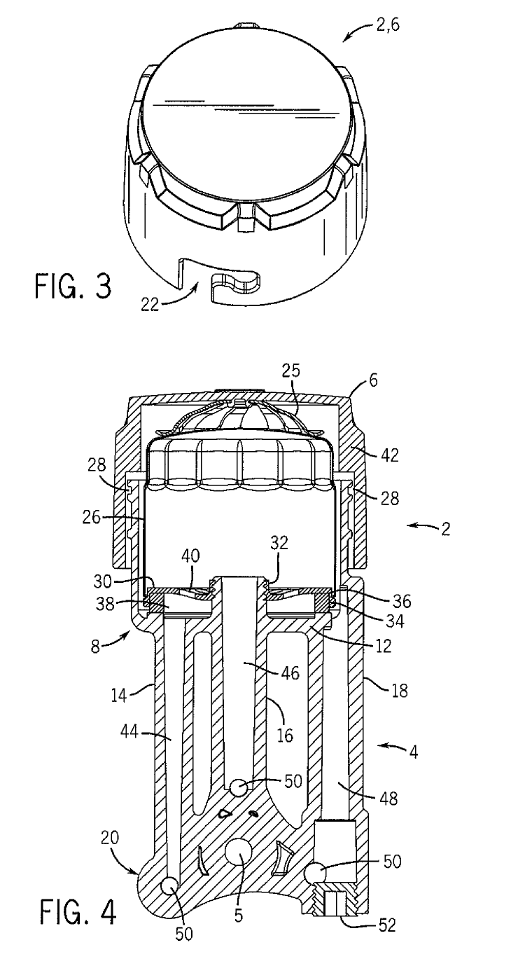

As shown in FIG. 3, the upper housing unit 6 is a cup-shaped cover that can be fitted over the cup-shaped portion 8 of the lower housing unit 4 so as to close the open upper end 10. In the embodiment shown, the upper housing unit 6 includes two slots or “quarter turn details” 22 (one of which is shown in FIG. 3) that are configured to interface and receive two complementary cylindrical protrusions 24 extending outward from opposite sides of the cup-shaped portion 8 of the lower housing unit 4. When appropriately placed over the lower housing unit 4 and rotated, the upper housing unit 6 is locked onto the lower housing unit due to the interaction of the quarter turn details 22 and cylindrical protrusions 24 in combination with an internal spring 25 (discussed further below). In alternate embodiments, the upper housing unit 6 and lower housing unit 4 could have female and male threads, respectively, allowing the upper housing unit to be screwed onto the lower housing unit.

Referring additionally to FIG. 4, a cross-sectional view of the oil filter assembly 2 when fully assembled is provided. As shown, the assembly 2 includes an annular spin-on oil filter 26 supported within the housing units 4,6. Also, a sealing element (e.g., an 0-ring) 28 is positioned between interfacing cylindrical surfaces of the lower and upper housing units 4,6 so as to keep oil from leaking out of the assembly 2 between those units. The filter 26 is supported in an inverted manner, i.e., top end down with a sealed portion of an inner cylindrical surface 30 being in contact with a tubular boss or protrusion 32 extending from the closed lower end 12 of the cup-shaped portion 8 of the lower housing unit 4. A further annular seal 36 extends circumferentially around the tubular protrusion 32 and is in axial contact with a circular ridge 34 also protruding upward from the closed lower end 12 of the cup-shaped portion 8. The ridge 34 serves as a gasket sealing surface and is substantially perpendicular to the tubular protrusion 32.

As discussed above, the filter 26 is a spin-on filter and, as such, the sealed portion of the inner cylindrical surface 30 has female threads that interface complementary male threads on the tubular protrusion 32 (the threads are not shown in FIG. 4). With such a design, the spin-on filter can easily be coupled to the lower housing unit 4, simply by rotating the filter onto the protrusion 32. Also as shown in FIG. 4, the spring 25 discussed above is positioned between the top of the upper housing unit 6 and the top of the filter 26. The spring 25 tends to push the upper housing unit 6 away from the lower housing unit 4, thereby causing the quarter turn details 22 and protrusions 24 to become positioned so as to prevent relative rotational movement of the upper and lower housing units and to keep those housing units locked together.

Further as shown in FIG. 4, the respective supports 14, 16 and 18 contain an unfiltered oil passage 44, a filtered oil passage 46 and a drain passage 48, respectively. The unfiltered oil passage 44 provides a channel by which unfiltered oil is communicated from the base 20 (and the engine) to an annular space 38 existing between the tubular protrusion 32 and the annular seal 36/circular ridge 34. The unfiltered oil provided to the annular space 38 further then proceeds into the interior of the filter by way of multiple holes 40. Upon being filtered, the oil then proceeds into an interior cavity within the filter defined by the inner cylindrical surface 30 and subsequently into the filtered oil passage 46, which begins at the top of the tubular protrusion 32 and continues down to (or nearly to) the base 20, ending above the bolt hole 5. The filter media and interior flow paths of the filter are not shown but are well-known in the art.

FIG. 4, and the above descriptions, are for filtered and unfiltered oil paths that follow the normal convention. If a spin-on filter was available with reversed flows, the invention would work equally as well.

To the extent that oil may leak between the annular seal 36 and circular ridge 34, from the annular space 38 to an exterior region 42 existing between the housing units 4,6 and the filter 26, such oil is communicated into the drain passage 48. Upon reaching the drain passage 48, the oil is further communicated back to the engine crankcase or to another appropriate place, such as a drain pan. FIG. 4 shows ends 50 of the passages 44, 46 and 48 at or proximate to the base 20 where the passages are coupled to corresponding passages of the engine. In the present embodiment, because the drain passage 48 is positioned along the side of the lower housing unit 6, the die used to create the drain passage is inserted from the bottom of the lower housing unit rather than the top (as in the cases of the passages 44,46). Consequently, FIG. 4 also shows a plug 52 to be inserted at the bottom of the drain passage 48 to plug a location where the die was inserted. The ends 50 are formed separately from the remaining portions of the passages 44, 46, and 48 and extend generally outward from the page as viewed in FIG. 4.

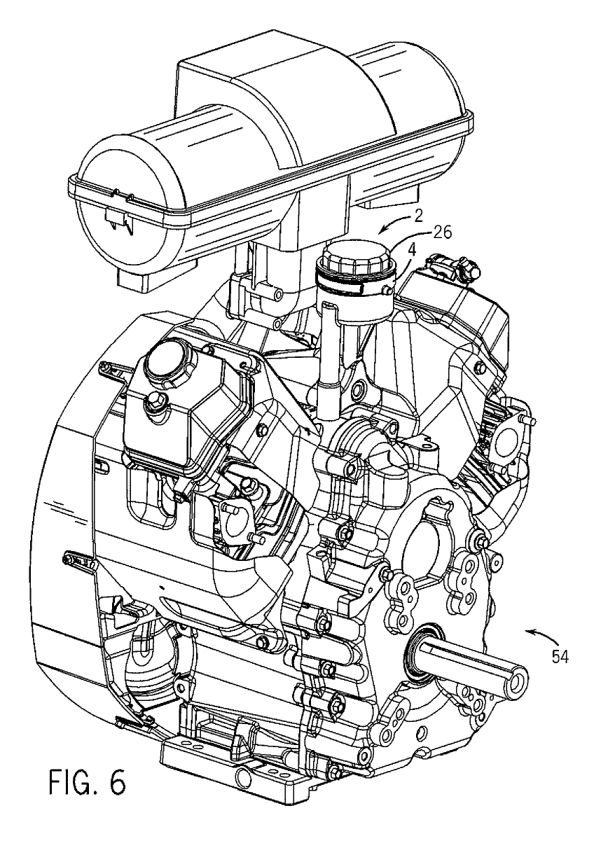

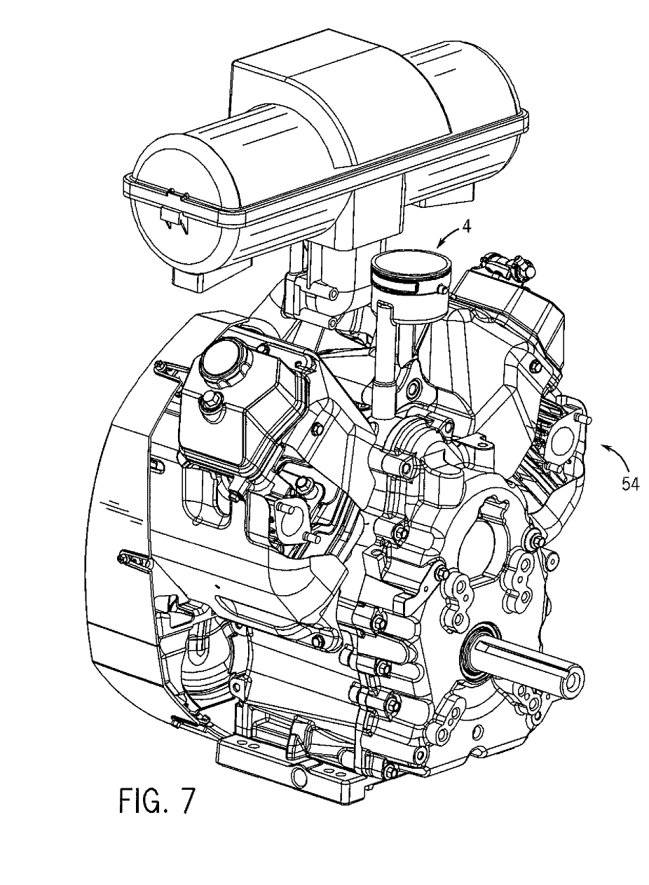

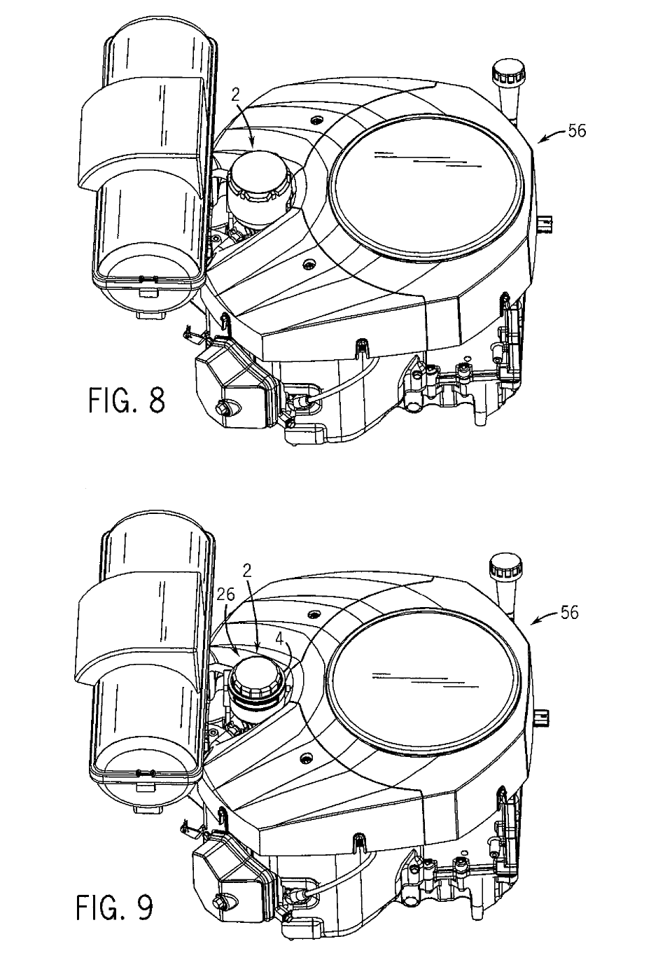

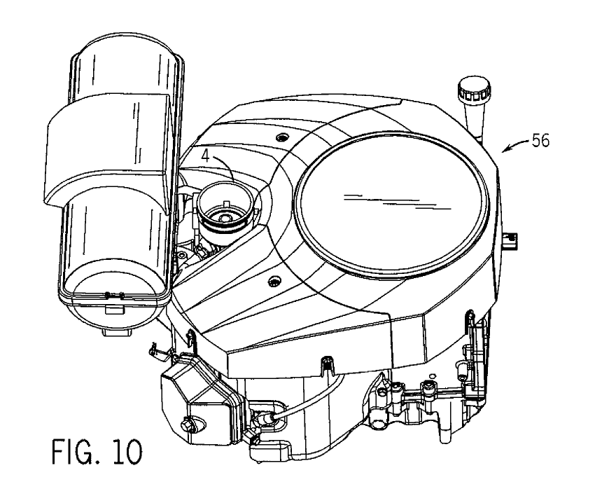

Turning to FIGS. 5-10, the oil filter assembly 2 is shown to be implemented in conjunction with two different engines. In particular, FIGS. 5-7 show the oil filter assembly 2 to be mounted on a horizontal crankshaft engine 54, while FIGS. 8-10 show the assembly to be mounted on a vertical crankshaft engine 56. In each case, the oil filter assembly 2 is shown to be mounted in such a manner that cup-shaped portion 8 of the lower housing unit 4 and the upper housing unit 6 are positioned at or above the top of the engine to allow for easy access to the oil filter assembly, for maintenance purposes (e.g., filter replacement and oil changing) or otherwise. In particular, FIGS. 6 and 9 show the oil filter assembly 2 with the upper housing unit 6 removed, while FIGS. 7 and 10 show the oil filter assembly with both the upper housing unit and the oil filter 26 removed.

The design of the oil filter assembly 2, and the location of the oil filter assembly relative to the engine on which it is mounted, in particular facilitate the changing of oil and the changing of the oil filter without spilling oil (on the engine or on the ground) in the process. Oil within the spin-on filter 26 that is released upon the opening of the upper housing unit 6 and unscrewing of the spin-on filter merely proceeds into the drain passage 48 and into the engine. Oil can also be easily added to an engine, either with the filter removed, or with the filter in place, for example, by pouring oil over the filter and allowing the oil to drain into the drain passage. Use of the oil filter assembly for addition of refill oil can be facilitated if the sidewall of the cup-shaped portion 8 is eccentric to the filter and/or has a non-circular cross-section. Such eccentricity or non-circularity will result in a region having a larger clearance between the filter and the sidewall, thereby providing a convenient location to pour in the refill oil.

This invention provides for a more readily accessible mounting location on an internal combustion engine for a spin-on type oil filter, and a means for service (removal) of that spin-on type oil filter without spilling any oil (on the engine or on the ground) in the process. Further, the invention allows for improved installation of a new spin-on oil filter without use of tools, and without potential long-term leakage of oil (on the engine or on the ground) due to improper tightening of the filter (any leakage past the spin-on filter gasket will be returned to the engine crankcase via the drain passage). Still further, the invention can be used as the primary engine oil fill (with the filter removed for oil change or with the filter in place for adding small amounts of oil between changes).

It is specifically intended that the present invention not be limited to the embodiments and illustrations contained herein, but include modified forms of those embodiments including portions of the embodiments and combinations of elements of different embodiments as come within the scope of the following claims.

What is claimed is:

1. An oil filter housing comprising:
a lower housing unit comprising a sidewall connected to a bottom surface to form an open-topped chamber;
a male threaded portion extending up from the bottom surface adapted to mount a spin-on oil filter;
a flat gasket sealing surface on the bottom surface, wherein the gasket sealing surface is perpendicular to the male threaded portion;
a first passage adapted to permit dirty oil to flow to an oil filter mounted on the male threaded portion;
a second passage adapted to permit filtered oil to flow away from an oil filter mounted on the male threaded portion;
a third passage adapted to permit drainage of oil from the open-topped chamber, wherein the third passage is located in the bottom surface outside of the gasket sealing surface; and,
an upper housing unit removably attached to the lower housing unit, wherein the upper housing unit is adapted to cover the open-topped chamber,
wherein the oil filter housing is adapted to allow a spin-on oil filter to be mounted in a normally inverted position on or above a top side of an internal combustion engine.

2. The oil filter housing of claim 1, wherein the first passage is located in the bottom surface inside the gasket sealing surface.

3. The oil filter housing of claim 1, wherein the second passage is located in the male threaded portion.

4. The oil filter housing of claim 1, wherein the lower housing unit is integrally formed with an engine crankcase.

5. The oil filter housing of claim 1 wherein the lower housing unit is mountable to an engine crankcase.

6. The oil filter housing of claim 5 wherein the lower housing is mounted to a crankcase by three supports.

7. The oil filter housing of claim 1, wherein the upper housing unit mates with the lower housing unit to form a seal sufficient to contain oil within the chamber.

8. The oil filter housing of claim 1, further comprising means for securing the attachment of the lower housing unit to the upper housing unit.

9. The oil filter housing of claim 8, wherein the means for securing comprise complementary threads on the upper housing unit and the lower housing unit or complementary quarter-turn details on the upper housing and the lower housing.

10. The oil filter housing of claim 1, wherein the upper housing unit overlaps the sidewall.

11. The oil filter housing of claim 1, wherein the lower housing is further adapted to facilitate adding refill oil to the crankcase.

12. The oil filter housing of claim 1, wherein the sidewall is concentric with the male threaded portion.

13. An oil filter housing assembly comprising:
an engine crankcase having a top side;
a lower housing unit mounted onto the engine crankcase, comprising a sidewall connected to a bottom surface to form an open-topped chamber, wherein the lower housing is adapted to allow a spin-on oil filter to be mounted in a normally inverted position on or above the top side of the crankcase;
a male threaded portion extending up from the bottom surface adapted to mount a spin-on oil filter;
a flat gasket surface on the bottom surface, wherein the gasket surface is perpendicular to the male threaded portion;
a first passage adapted to permit dirty oil to flow to an oil filter mounted on the male threaded portion;
a second passage adapted to permit filtered oil to flow away from an oil filter mounted on the male threaded portion;
a third passage adapted to permit drainage of oil from the open-topped chamber, wherein the third passage is located in the bottom surface outside of the gasket surface; and,
an upper housing unit removably attached to the lower housing unit, wherein the upper housing unit is adapted to cover the open-topped chamber.

14. The assembly of claim 13, wherein the first passage is located in the bottom surface inside the gasket surface.

15. The assembly of claim 13, wherein the second passage is located in the male threaded portion.

16. The assembly of claim 13, wherein the upper housing unit mates with the lower housing unit to form a seal sufficient to contain oil within the chamber.

17. The assembly of claim 13, further comprising means for securing the attachment of the lower housing unit to the upper housing unit.

18. The assembly of claim 17, wherein the means for securing comprise complementary threads on the upper housing unit and the lower housing unit or complementary quarter-turn details on the upper housing and the lower housing.

19. The assembly of claim 13, wherein the upper housing unit overlaps the sidewall.

20. The assembly of claim 13, wherein the lower housing is further adapted to facilitate adding refill oil to the crankcase.

21. The assembly of claim 13, wherein the sidewall is approximately circular.

22. The assembly of claim 13, wherein the lower housing unit is mounted to the crankcase by at least one support.

23. The assembly of claim 13, wherein the lower housing unit is mounted to the crankcase by at least two supports.

24. The assembly of claim 13, wherein the lower housing unit is mounted to the crankcase by at least three supports.

25. A method for installing an oil filter, the method comprising
providing an open-topped cup shaped lower housing unit having a male threaded portion extending up from a bottom surface of the lower housing unit adapted to mount a spin-on oil filter,
wherein the lower housing unit is adapted to allow a spin-on oil filter to be mounted in a normally inverted position on or above a top side of an internal combustion engine;
mounting a spin-on oil filter to the male-threaded portion such that openings for ingress of dirty oil to the oil filter are in fluid communication with a first passage in the lower housing unit adapted to permit dirty oil to flow to the filter; and
wherein openings in the oil filter to allow egress of filtered oil are in fluid communication with the second passage in the lower housing unit adapted to permit filtered oil to flow away from the oil filter.

26. The method of claim 25, wherein the lower housing unit is mounted to a crankcase by means of three supports.

27. The method of claim 25, wherein the lower housing unit further comprises a third passage adapted to permit drainage of oil from the lower housing unit to a crankcase.

28. The method of claim 25 wherein the lower housing unit mates with a removable upper housing unit.

29. A method for filling oil to a crankcase, the method comprising:
providing a cup-shaped open-topped lower housing unit adapted to allow a spin-on oil filter to be mounted in a normally inverted position on or above a top side of an internal combustion engine,
wherein the lower housing unit comprises a passage adapted to permit drainage of oil from the lower housing unit to a crankcase of the internal combustion engine; and
wherein the lower housing unit further comprises a male threaded portion extending from a bottom surface of the lower housing unit, the male threaded portion adapted to mount a spin-on oil filter; and
pouring oil into the lower housing unit such that the oil can flow into the crankcase via the passage.

30. The method of claim 29, wherein a spin-on oil filter is mounted to the male threaded portion such that the drainage passage is located in a space between an outer wall of the spin-on oil filter and an inner wall of the lower housing unit and
wherein the oil is poured on top of the oil filter and/or between the oil filter and the lower housing unit walls.

31. The method of claim 29 wherein the lower housing unit mates with a removable upper housing unit.

32. An oil filter housing assembly comprising:
an engine crankcase having a top side;
a lower housing unit integrally formed with the engine crankcase, comprising a sidewall connected to a bottom surface to form an open-topped chamber, wherein the lower housing is adapted to allow a spin-on oil filter to be mounted in a normally inverted position on or above the top side of the crankcase;
a male threaded portion extending up from the bottom surface adapted to mount a spin-on oil filter;
a flat gasket surface on the bottom surface, wherein the gasket surface is perpendicular with the male threaded portion;
a first passage adapted to permit dirty oil to flow to an oil filter mounted on the male threaded portion;
a second passage adapted to permit filtered oil to flow away from an oil filter mounted on the male threaded portion;
a third passage adapted to permit drainage of oil from the open-topped chamber, wherein the third passage is located in the bottom surface outside of the gasket surface; and,
an upper housing unit removably attached to the lower housing unit, wherein the upper housing unit is adapted to cover the open-topped chamber.

33. The assembly of claim 32, wherein the first passage is located in the bottom surface inside the gasket surface.

34. The assembly of claim 32, wherein the second passage is located in the male threaded portion.

35. The assembly of claim 32, wherein the upper housing unit mates with the lower housing unit to form a seal sufficient to contain oil within the chamber.

36. The assembly of claim 32, further comprising means for securing the attachment of the lower housing unit to the upper housing unit.

37. The assembly of claim 36, wherein the means for securing comprise complementary threads on the upper housing unit and the lower housing unit or complementary quarter-turn details on the upper housing and the lower housing.

38. The assembly of claim 32, wherein the upper housing unit overlaps the sidewall.

39. The assembly of claim 32, wherein the lower housing is further adapted to facilitate adding refill oil to the crankcase.

40. The assembly of claim 32, wherein the sidewall is non-concentric with the male threaded portion.
